(19) United States
(12) Patent Application Publication
(10) Pub. No.: US 2008/0208579 A1
(43) Pub. Date: Aug. 28, 2008

(54) Session recording and playback with selective information masking

(75) Inventors: Brian Weiss, Givat Shmuel (IL); Ran Achituv, Hod Hasharon (IL); David Bruce, Shoham (IL); Shai Levi, Hod Hasharon (IL); Ariel Shemesh, Jerusaelm (IL); Saar Carmi, Ramat Gan (IL); Arie Zaks, Kfar-Saba (IL)

Correspondence Address: ABELMAN, FRAYNE & SCHWAB, 666 THIRD AVENUE, 10TH FLOOR, NEW YORK, NY, 10017, US

(73) Assignee: VERINT SYSTEMS LTD.

(21) Appl. No.: 11/712,933

(22) Filed: Feb. 27, 2007

(51) Int. Cl. G10L 15/02

(52) U.S. Cl. 704/244; 707/E17.014

(57) ABSTRACT

A computer-implemented method for session processing includes identifying a type of data item that is presented to a user by a computerized system. A session in which the user interacts with the computerized system is recorded. A data item of the identified type is automatically detected in the recorded session. The recorded session is replayed, while refraining from presenting the detected data item in the replayed session.

### FIELD OF THE INVENTION

The present invention relates generally to data recording systems, and particularly to methods and systems for recording and replaying computer activity and voice sessions.

### BACKGROUND OF THE INVENTION

Session recording and playback are used in a variety of systems and applications. For example, contact centers (call centers) often record and store the computer screen activity and/or voice interaction with customers. The recorded sessions can be retrieved and played-back, such as for resolving a dispute with a customer regarding a transaction performed during the session or for monitoring the quality and performance of service representatives.

Several session recording methods and systems are known in the art. For example, Verint® Systems Inc. (Melville, N.Y.), offers a product family called ULTRA, which provides recording and playback of customer interactions for contact centers, including call recording and screen capture. Details regarding these products can be found at www.verint.com/contact_center.

As another example, Proxy Networks, Inc. (Cambridge, Mass.) offers a virtual router for remote control applications called Proxy Gateway Server. The product is able, among other functions, to capture, record and play back the activity on a remote computer screen. Information regarding this product can be found at www.proxynetworks.com/products/proxy_gateway.shtml.

### SUMMARY OF THE INVENTION

There is therefore provided, in accordance with an embodiment of the present invention, a computer-implemented method for session processing, including:

identifying a type of data item that is presented to a user by a computerized system;

recording a session in which the user interacts with the computerized system;

automatically detecting a data item of the identified type in the recorded session; and

replaying the recorded session, while refraining from presenting the detected data item in the replayed session.

In some embodiments, the computerized system includes a contact center application. In another embodiment, the computerized system provides the user with access to a remote computer by communicating with the remote computer over a communication link.

In yet another embodiment, replaying the recorded session includes presenting the replayed session to a reviewer different from the user, and refraining from presenting the detected data item includes preventing exposure of the data item to the reviewer.

In still another embodiment, the data item is displayed to the user on a computer display of the computerized system, and refraining from presenting the detected data item includes masking an area of the display in which the data item is displayed when replaying the session. Identifying the type of data item may include identifying a logical definition of the type of data item in an application running on the computerized system, irrespective of a form in which the data item is displayed on the computer display.

In a disclosed embodiment, identifying the logical definition includes:

running the application on a definition terminal;

indicating a location on a display of the definition terminal in which the data item is displayed;

interacting with an operating system of the definition terminal, so as to determine a Graphical User Interface (GUI) object that is displayed at the indicated location and is associated with the data item; and

determining the logical definition of the type of data item based on the determined GUI object.

In some embodiments, the computerized system includes a voice communication system, recording the session includes recording voice that is exchanged between the user and the voice communication system, automatically detecting the data item includes automatically detecting an enunciation of the data item in the recorded voice, and replaying the recorded session includes replaying the recorded voice while refraining from enunciating the data item.

In another embodiment, the computerized system presents electronic mail (e-mail) messages to the user during the session, and refraining from presenting the detected data item includes masking the detected data item in the e-mail messages that are presented in the replayed session.

In yet another embodiment, recording the session includes detecting and masking the data item at a computer with which the user interacts when recording the session. Additionally or alternatively, recording the session includes sending the recorded session over a network to a server, and detecting and masking the data item at the server. Further additionally or alternatively, recording the session includes storing the recorded session in a storage device without omitting the data item, and replaying the recorded session includes retrieving the recorded session from the storage device and masking the data item when replaying the session.

In an embodiment, recording the session includes storing the recorded session in a storage device without omitting the data item, and the method includes subsequently retrieving the recorded session, masking the data item and storing the session having the masked data item in the storage device.

In another embodiment, identifying the type of data item includes defining a condition, and refraining from presenting the detected data item includes evaluating the condition and refraining from presenting the detected data item when the condition is met. The condition may depend on at least one variable selected from a group of variables consisting of a value of the data item, a value of another data item, an authorization level of a reviewer who replays the session and an authorization level permitted to access the data item.

In some embodiments, the computerized system includes a voice communication system, recording the session includes recording voice interaction between the user and the voice communication system and Computer Telephony Integration (CTI) data associated with the voice interaction, and the condition depends on the recorded CTI data.

Evaluating the condition may include interacting with an operating system on which the computerized system runs, without interacting with the computerized system directly.

In a disclosed embodiment, the recorded session includes recorded voice and recorded computer screen activity, the condition depends on at least one information type selected from a group of types consisting of information obtained from the recorded voice and information obtained from the recorded computer screen activity, and refraining from presenting the detected data item includes masking the detected data item in at least one medium selected from a group of media consisting of replayed voice and replayed computer screen activity.

There is additionally provided, in accordance with an embodiment of the present invention, a session processing apparatus, including:

an input device and an output device, which are, arranged to interact with a user of a computerized system; and

one or more processors, which are arranged to accept an identification of a type of data item that is presented to the user by the computerized system, to record a session in which the user interacts with the computerized system using the input and output devices, to automatically detect a data item of the identified type in the recorded session, and to replay the recorded session, while refraining from presenting the detected data item in the replayed session.

There is further provided, in accordance with an embodiment of the present invention, a session processing apparatus, including:

means for identifying a type of data item that is presented to a user by a computerized system;

means for recording a session in which the user interacts with the computerized system;

means for automatically detecting a data item of the identified type in the recorded session; and

means for replaying the recorded session, while refraining from presenting the detected data item in the replayed session.

There is also provided, in accordance with an embodiment of the present invention, a computer software product for session processing, the product including a computer-readable medium, in which program instructions are stored, which instructions, when read by one or more processors, cause the processors to interact with a user of a computerized system, to accept an identification of a type of data item that is presented to the user by the computerized system, to record a session in which the user operates the computerized system using the input and output devices, to automatically detect a data item of the identified type in the recorded session, and to replay the recorded session, while refraining from presenting the detected data item in the replayed session.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a contact center, in accordance with an embodiment of the present invention;

FIGS. 2A and 2B are screenshots that schematically illustrate a Graphical User Interface (GUI) of an operator terminal, in accordance with an embodiment of the present invention;

FIG. 3 is a flow chart that schematically illustrates a method for session recording and playback with selective information masking, in accordance with an embodiment of the present invention;

FIG. 4 is a block diagram that schematically illustrates an operator terminal, in accordance with an embodiment of the present invention; and

FIG. 5 is a flow chart that schematically illustrates a method for specifying sensitive data items for masking, in accordance with an embodiment of the present invention.

### DETAILED DESCRIPTION OF EMBODIMENTS

### Overview

Recorded sessions often comprise sensitive information. For example, financial applications may display customer credit card numbers or bank account numbers. Healthcare applications may display sensitive medical information. A service provider application may display user passwords or personal access codes. Other displayed information may be of a commercially-sensitive nature. The voice content of a session may also contain sensitive information.

In many cases, it is advantageous to omit the sensitive information when playing back a recorded session. For example, some regulatory requirements and industry standards restrict the exposure of financial, medical and other sensitive information. In some cases, the persons who play back the sessions may not be authorized to view the sensitive information. Omitting the sensitive information from replayed sessions is usually tolerable, since in many cases the omitted information is irrelevant in the context of session playback. For example, when replaying sessions in order to monitor the performance of service representatives, personal customer information is irrelevant.

In order to prevent unnecessary exposure of sensitive information, embodiments of the present invention provide methods and systems for selectively masking information in played-back sessions. The methods and systems described herein address sensitive information that is presented in different forms, e.g., sensitive information that is displayed visually on the operator computer screen, or sensitive information that is contained in the recorded voice interaction of the session.

In some embodiments, an administrative user specifies types of sensitive data items that should be masked in the played-back sessions. The sensitive data types are specified in terms of their logical definition in the application, so that masking of these items is performed irrespective of the current size, layout or appearance of the screen. An exemplary method for specifying sensitive data items is described hereinbelow.

The sensitive data items are automatically identified and masked, so that their content is not presented in the played-back session. In visual masking, the sensitive data item is typically replaced by an area having a certain color or pattern. In voice masking, the enunciation of the sensitive data items is typically replaced by a silent period or an audible tone.

The identification and masking operations can be carried out when the session is recorded at the operator terminal, when the recorded session is stored, or when the recorded session is played back. Sessions can also be masked in post-processing, i.e., stored without masking, retrieved, masked and stored again. Several different masking configurations, and the trade-offs between them, are described hereinbelow. In some embodiments, the sensitive information of a session can be masked in different manners, in accordance with predefined rules or conditions. For example, different levels of masking can be used when replaying the session to viewers having different authorization levels.

Several system configurations and applications that use selective data masking are described hereinbelow, such as, for example, contact center applications and remote control or remote access applications.

### System Description

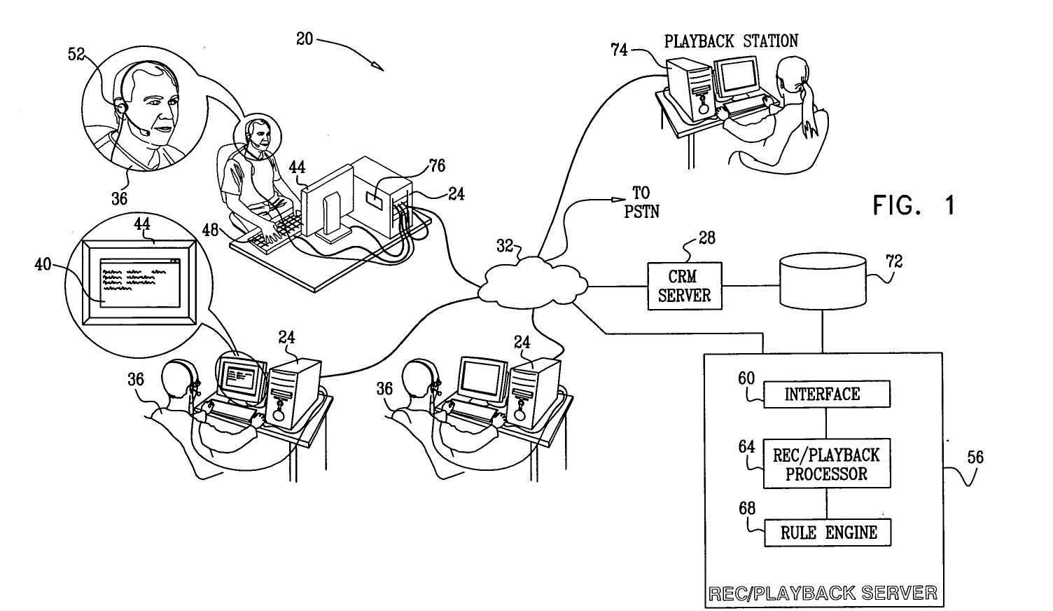

FIG. 1 is a block diagram that schematically illustrates a contact center 20, in accordance with an embodiment of the present invention. Contact center 20 is typically operated by an organization, such as a financial enterprise or an emergency service, for interacting and providing service to customers. The contact center comprises multiple operator terminals 24, which run a contact center application, e.g., a Customer Relationship Management (CRM) application. In the present example, the contact center application comprises a client-server application, in which terminals 24 communicate with a CRM server 28 over a communication network 32. Terminals 24 may comprise any suitable computer. Network 32 may comprise a Local Area Network (LAN), a Wide-Area Network (WAN) such as the Internet, or any other suitable network.

Users 36, such as service representatives or other operators, conduct sessions using terminals 24 so as to provide service to customers. During the session, the contact center application displays information 40 using a display 44 of terminal 24. The displayed information may comprise, for example, customer details, details regarding a transaction that is being performed during the session, or any other suitable information. The user may enter data, manipulate the displayed information or otherwise operate the contact center application using an input device 48, such as a keyboard or mouse of terminal 24.

The session conducted by user 36 usually involves voice interaction with the customer. In the exemplary configuration of FIG. 1, the service representative uses a headset 52, which is connected to a Voice over IP (VoIP) telephone (not shown) in terminal 24. As such, voice content and signaling is transported over network 32 and is routed to a telephone network, such as a Public Switched Telephone Network (PSTN). Alternatively, voice interaction may be carried out by a telephone network that is separate from network 32, such as using telephone sets connected to a Private Automatic Branch exchange (PABX). Further alternatively, voice interaction may be carried out using any other suitable voice communication system, such as a cellular system or a trunked radio system. Such voice systems are typically computerized, digital systems, and the recording of voice interaction is typically implemented using digital means, regardless of whether the voice system is integrated with or separate from network 32.

The sessions conducted in contact center 20 may involve other types of media and other modes of interaction and communication. For example, users 36 may communicate via e-mail with customers during the session.

Contact center 20 comprises a recording/playback server 56, which records, stores and plays back customer interaction sessions that are conducted by users 36 using terminals 24. As noted above, the recorded sessions can later be used for various purposes, such as for resolving disputes with customers or for monitoring service representative performance. Recorded sessions can also be analyzed in order to learn and improve CRM processes, as well as for providing business intelligence.

Server 56 comprises a network interface 60, which connects the server to network 32, and a recording/playback processor 64, which carries out the recording and playback methods described herein. In some embodiments, server 56 comprises a rule engine 68, which is used for rule-based detection and masking of sensitive data items, as will be explained in detail below.

Recording a session conducted on a particular terminal 24 comprises capturing information 40 displayed on display 44 of the terminal, capturing the actions of input device 48 (e.g., mouse movements and keyboard keystrokes), and/or recording the voice interaction with the voice communication system. The recorded sessions are stored in a database 72 or other storage device, which may be accessible to or separate from CRM server 28. Stored sessions can be played back on one of terminals 24 or on a dedicated playback station 74. In different contact center configurations, recorded sessions may comprise recorded screen activity, recorded voice or a combination of the two media.

In some embodiments, the sessions are recorded by recording agents 76, which reside in terminals 24. Agents 76 record the session information and transmit the recorded information to server 56 over network 32. The recording agents may use any suitable method or format for recording and representing the recorded session information, and any suitable communication protocol for communicating the recorded information to server 56. For example, recording and communication may be carried out using known remote control or remote access protocols, such as the Virtual Network Computing (VNC) protocol, which is offered by RealVNC Ltd. (Cambridge, United Kingdom). Details regarding VNC are available at www.realvnc.com.

Typically, terminals 24 and recording/playback server 56 comprise general-purpose computers, which are programmed in software to carry out the functions described herein. The software may be downloaded to the computers in electronic form, over a network, for example, or it may alternatively be supplied to the computers on tangible media, such as CD-ROM.

The methods and systems described herein can be used to carry out selective information masking in any other media type or interaction mode, which may be used in contact center 20. For example, when users 36 communicate with customers via e-mail, the methods and systems described herein can be used to selectively mask certain e-mail fields or other objects when replaying recorded e-mail sessions.

Although the embodiments described herein mainly address contact centers that run CRM applications, the methods and systems described herein can be used in any other computerized application that presents information to a user. For example, the methods and systems described herein can be used to mask sensitive information in remote control and remote access applications. In these applications, a user of a local terminal communicates with a remote computer over a communication link, such as a point-to-point connection or a network. The user views the screen activity of the remote computer on a local display and may sometimes control the remote computer using a local input device. Using the methods described herein, sensitive information that is displayed on the remote computer can be masked when displayed on the local terminal display.

An exemplary remote control application, which can be used in conjunction with the selective information masking functionality described herein, is the pcAnywhere™ software product, which is offered by Symantec Corp. (Cupertino, Calif.). Details regarding pcAnywhere are available at www.symantec.com/enterprise/products/overview.jsp?pcid=10 25&pvid=84_{—}1. Alternatively, the remote control or remote access application may use the VNC protocol, cited above. The selective masking methods described herein can be embodied, mutatis mutandis, in any other remote control or remote access application.

Further alternatively, the principles of the present invention can also be used in any other application in which screen activity and/or voice is recorded and played back, such as, for example, on-line seminars (“webinars”), remote learning applications, conferencing applications, government surveillance systems, regulatory adherence monitoring applications, fraud detection applications, public safety centers, financial trading floor applications, air traffic control systems and many others.

### Selective Masking of Session Information

The recorded sessions often comprise sensitive information, whose exposure should be minimized and restricted. For example, financial applications may display customer credit card numbers or bank account numbers. Healthcare applications may display private medical information together with information that identifies the customer. A service provider application may display user passwords or personal access codes. Other information may be commercially sensitive or sensitive for any other reason. Sensitive information may be displayed on display 44 of terminal 24 and/or contained in the voice interaction of the session.

In many cases, it is desirable to refrain from presenting the sensitive information when playing back a recorded session. For example, when a session is played back in order to monitor the conduct and performance of a service representative, personal customer information is irrelevant. In some cases, regulatory requirements and industry standards restrict the exposure of sensitive financial, medical or other information. For example, credit card companies issue regulations for protecting cardholder information, and healthcare industry regulations protect patient health records. Moreover, the person who plays back the session may not be authorized to view the sensitive information.

In order to prevent unnecessary exposure of sensitive information when playing back recorded sessions, embodiments of the present invention provide methods and systems for selectively masking information in the played-back session. The methods and systems described herein address sensitive information that is presented to the user using any suitable presentation means, e.g., sensitive information that is displayed on display 44 of terminal 24 or sensitive information that is contained in the recorded voice interaction of the session. In the context of the present patent application and in the claims, the term “presenting information” is used broadly to describe any form of conveying information to a user, in a manner that can be appreciated by one or more of the user's senses. For example, information may be presented visually, audibly or in any other form.

In the context of the present patent application and in the claims, the term “session” is used to describe any type of interaction in which information is presented to a user. Although in some cases the sessions are time-constrained interactions having well-defined beginning and end, other types of sessions may not be time-constrained and may have on-going, streaming characteristics. Moreover, the term “recording” is used herein to describe any action that obtains some or all of the information conveyed during a session, without necessarily storing the information. In some cases, recorded information may be stored or cached. In other cases, such as in real-time monitoring, remote control or remote access applications, the recorded information is used to reconstruct the session in real-time, without necessarily storing or caching the information.

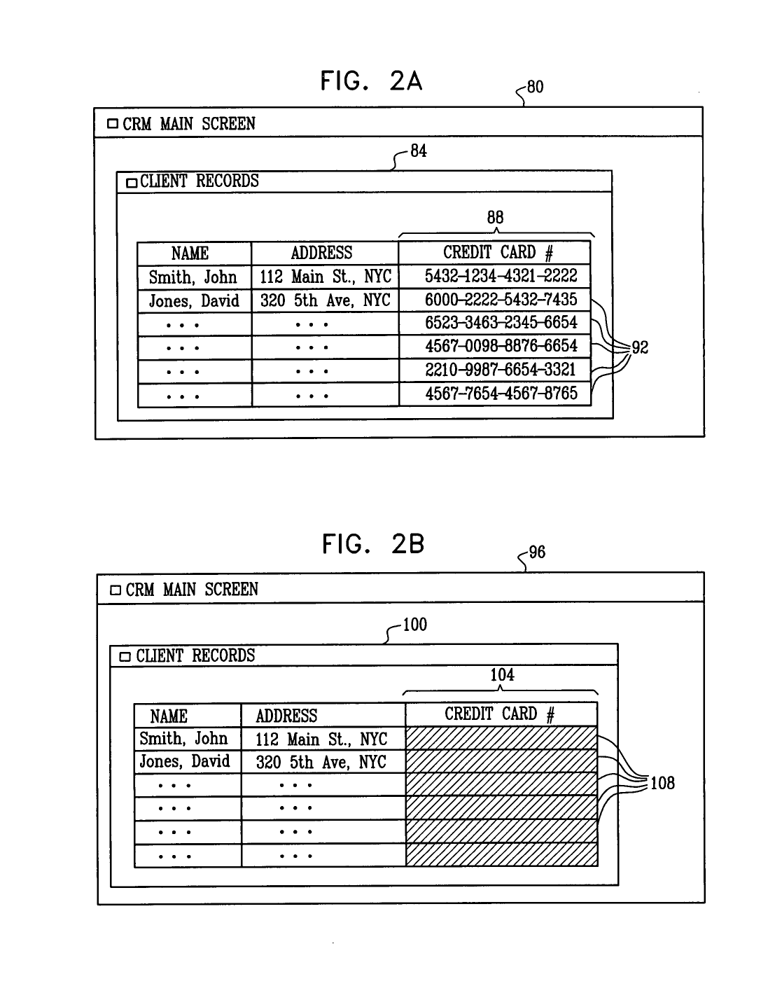

FIG. 2A is a screenshot that schematically illustrates a Graphical User Interface (GUI) screen of an exemplary contact center application running on terminal 24, in accordance with an embodiment of the present invention. The GUI comprises a main window 80, as displayed by terminal 24 during an exemplary session. A client records window 84 displays a table of customer records, which include various data items such as customer names, addresses and credit card numbers. In particular, a column 88 comprises cells 92 that display customer credit card numbers. Cells 92 are thus considered to be sensitive data items.

FIG. 2B is a screenshot that schematically illustrates another Graphical User Interface (GUI) screen of the contact center application, in accordance with an embodiment of the present invention. The screenshot of FIG. 2B shows a playback view of the screenshot of FIG. 2A above, after the sensitive information has been masked. The display comprises a main window 96 and a client records window 100, which are similar to windows 80 and 84 of FIG. 2A above, respectively. In the playback view of FIG. 2B, however, cells 108 of a column 104, which originally displayed customer credit card numbers, are masked.

FIGS. 2A and 2B show an exemplary masking operation, which is chosen purely for the sake of conceptual clarity. Additionally or alternatively, any type of data item, such as windows, sub-windows, table entries, text boxes, check boxes, buttons, scroll bars, drop-down menus, lists, as well as graphical information such as images, diagrams, graphs and plots can be defined as containing sensitive information and masked accordingly. Any suitable color, pattern, icon or other visual mark can be displayed instead of the masked information. In some cases, the masked regions of the screen are marked with a distinctive color or pattern, so as to clearly indicate which data items have been masked.

Note that the sensitive data items may appear at varying locations on the screen. For example, the user may customize the information display, change the size, location or layout of the relevant window, or otherwise modify the location and appearance of the displayed sensitive data items. The masking operation, as will be explained in detail below, is typically related to the logical definition of the data item in the application, and not to a specific screen location or appearance. Thus, sensitive data items are masked regardless of the specific form (e.g., screen location, size, format, context or appearance) in which they are displayed.

Moreover, a certain sensitive data item can be displayed by the application in multiple views, windows or other GUI features. For example, a client credit card number may be displayed in a client record window, as shown in FIGS. 2A and 2B, as well as in a different window that displays the properties of a particular transaction of this customer. The same credit card number may appear in yet another display that lists currently-outstanding invoices. In some cases, views or screens of the application can be modified or added after the sensitive data item has been specified. However, since the sensitive data item is specified in terms of its logical definition in the application, the item will be masked, regardless of the view, screen or other object in which it is displayed by the application.

Although in most cases the masking operation is performed based on the logical definition of the data item, in some cases this technique can be combined with fixed masking, i.e., masking certain areas of the display regardless of their logical role.

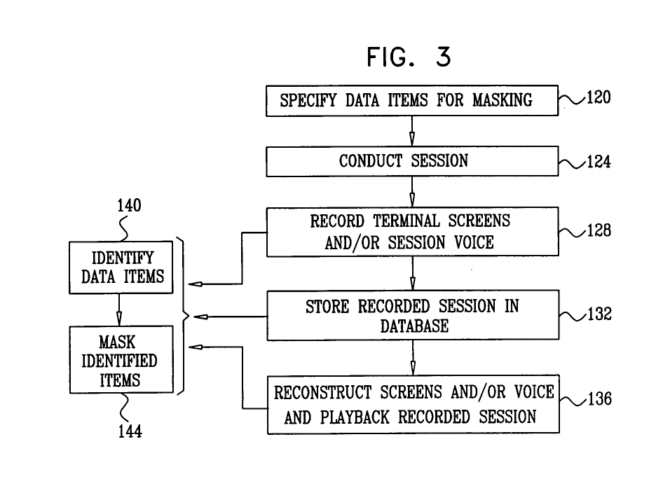

FIG. 3 is a flow chart that schematically illustrates a method for session recording and playback with selective information masking, in accordance with an embodiment of the present invention. The method begins with an administrative user, such as a system designer or administrator, specifying the sensitive data items, at an item specification step 120. The user specifies certain types of data items, which are presented by the contact center application, as sensitive data items that are to be masked in played-back sessions. Any number of sensitive data items can be defined. The sensitive data items may comprise data items that are displayed by the application on terminals 24 and/or data items which may appear in the voice content of the sessions.

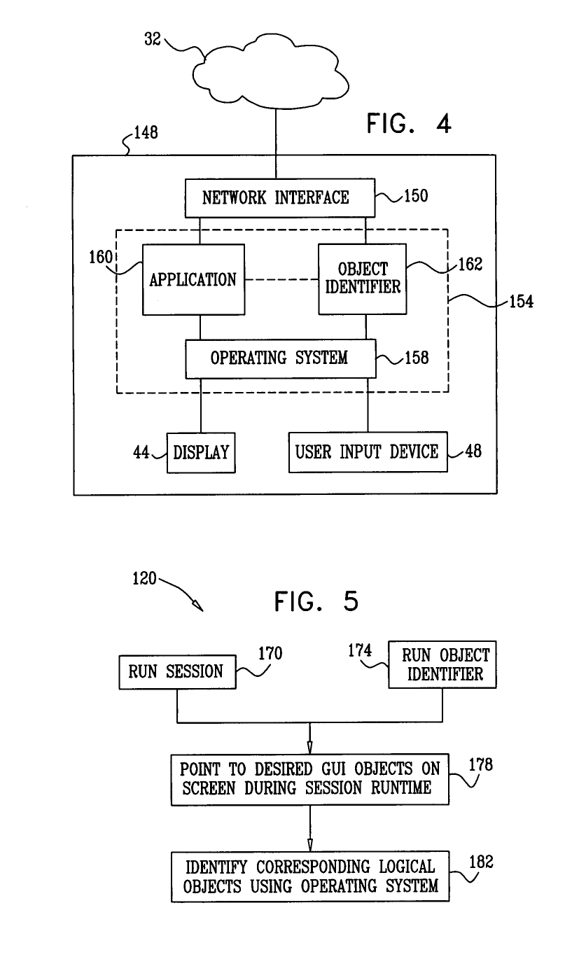

As noted above, the sensitive data items are specified in terms of their logical definition in the application, and not in terms of their appearance or screen location. For example, in the application shown in FIGS. 2A and 2B above, the application has a main screen, which has a client records sub-window. The client records sub-window displays a table, which comprises multiple fields. In the present example, a subset of these fields, i.e., the fields that display client credit card numbers, are selected and specified as sensitive data items. Since the sensitive data items are specified in terms of their logical definition in the application, these items can be identified and masked regardless of the current appearance or customization of the display. An exemplary method for specifying sensitive data items is described in FIGS. 4 and 5 below. Alternatively, any other suitable method can be used.

In some embodiments, the data item definition comprises attributes, which specify the conditions under which the data item is to be masked. For example, different persons who review the played-back sessions may have different authorization levels. The attributes of a sensitive data item may specify that the data item is to be masked when the session is played-back by a reviewer having a certain authorization level and remain visible when played-back by a reviewer having another authorization level.

As another example, the data item attributes may comprise logical rules that determine whether the item is masked or remains visible. Such rules may depend on the value of the data item, on values of other data items, or on any other variable or condition. For example, a rule may specify that a data item containing the total amount of a financial transaction is regarded as sensitive only if the amount exceeds a certain value. Another rule may specify that a data item containing the balance of a customer bank account is masked only when the balance is below a certain threshold. Yet another exemplary rule may state that a data item is masked only if the corresponding customer belongs to a certain category, such as to a class of preferred or premium customers.

The definitions of the various sensitive data items may be stored in recording/playback server 56, in recording agents 76 and/or in playback station 74. When the attributes comprise logical rules, the rules are stored and enforced by rule engine 68 in server 56. Alternatively, the rules may be stored and enforced locally in terminals 24 by recording agents 76.

Typically, the initial definition of the sensitive data items is performed off-line, i.e., before sessions are conducted in contact center 20. Definitions can be added, deleted and modified during normal operation of the contact center.

Users 36 conduct customer sessions using terminals 24 of contact center 20, at a session conducting step 124. During the sessions, the contact center application displays information to the users on displays 44 of terminals 24. In some cases, users 36 interact with customers using a voice communication system, e.g., using a telephone system.

Recording agents 76 record the session information, at a recording step 128. In a typical configuration, agent 76 records the screen activity and/or voice interaction of the session and transmits the recorded information over network 32 to server 56. Server 56 stores the recorded information in database 72, at a storage step 132. Agents 76 and/or server 56 may use various known data compression methods, in order to reduce the size of the data that is transmitted over network 32 and stored in database 72. Agents 76, server 56 and database 72 may use any suitable communication protocol for transferring the session information. The contact center may record all sessions or it may record and store only some of the sessions, in accordance with any suitable policy or criterion.

A user, referred to as a reviewer, may reconstruct and play back a recorded session, at a playback step 136. The session can be played-back either on one of terminals 24 or on playback station 74. Playback is carried out by a playback module, which is typically, but not necessarily, implemented in software. The playback module, which may reside in terminals 24 and/or in playback station 74, accepts the recorded session as input. When playing back the session, the playback module displays the recorded screen activity and/or plays the recorded voice interaction to the reviewer. The sensitive data items defined at item specification step 120 above are masked in the played-back session, so that the reviewer is not able to view and/or hear their content.

Typically, the reviewer selects and plays back a particular session that was previously stored in database 72. In some embodiments, however, the contact center enables real-time session monitoring, in which case the reviewer can monitor a session that is currently in progress.

Identification of the sensitive data items in the session and masking of the identified items can be performed by different system elements and at various stages of the session processing flow of steps 128-136 above. The identification and masking of the sensitive data items is carried out by a data masking module, which is typically, but not necessarily, implemented in software. The data masking module may reside in terminals 24, in server 56 and/or in playback station 74.

The data masking module identifies the sensitive data items, at an identification step 140, and masks the identified items, at a masking step 144, so as to refrain from displaying and/or enunciating their content in the replayed session. Since the sensitive data items are specified in terms of their logical definition in the application, the items are masked irrespective of their specific size, appearance or screen location.

In some embodiments, the data masking module resides in agents 76 in terminals 24. In these embodiments, the sensitive data items are identified and masked in the terminal, during or after the session is recorded at step 128 above. Thus, the information that is transmitted to server 56 and stored in database 72 is already selectively masked. This method offers a high degree of data security at the expense of operational flexibility. The information contained in the sensitive data items is lost and cannot be reconstructed, regardless of the application or of any rules or conditions.

In some cases, the data masking module identifies the sensitive data items by interacting with the operating system running on terminals 24, without any interaction with the contact center application. Such a configuration provides greater flexibility, transparency and tolerance to application modifications. In other cases, the data masking module may interact with both the operating system and with the contact center application. These configurations may be less flexible, but enable additional information, available only to the application, to be considered in the masking operation.

In alternative embodiments, the data masking module resides in server 56, and the sensitive data items are masked by the server before storing the recorded session in database 72. In these embodiments, server 56 has centralized control over the masking operation.

Further alternatively, the recorded session can be stored without masking, and the sensitive data items can be masked during (or immediately before) session playback. In these embodiments, the data masking module may reside either in server 56, or in the terminal or playback station that play back the session. This method enables a high degree of operational flexibility, since the stored session initially contains all session information. For example, different levels of masking can be carried out, depending on the identity or authorization level of the reviewer or based on any other rule or policy.

Further alternatively, the session can be initially recorded and stored without masking, and then masked and stored in post-processing. In these embodiments, the data masking module resides in server 56. The session is initially stored by server 56 in database 72 without masking. At a later stage, server 56 retrieves the session from database 72, performs masking and stores the masked session back in the database. The masked session can then be retrieved and played back whenever desired.

The data masking module may use different methods, rules or criteria for masking the sensitive data items in the voice interaction of the replayed session. For example, the data masking module may use various time-dependent criteria, such as masking the first ten seconds of the voice interaction (or any other known interval), during which the customer usually provides personal identification details.

An alternative configuration may mask the voice interaction in response to a certain trigger in the screen activity. For example, shortly after a text box for entering a credit card number is opened on the display, the customer is likely to provide his credit card number. Therefore, masking the voice in the time interval that immediately follows the appearance of such a feature on the screen is likely to mask the enunciation of the credit card number.

Further additionally or alternatively, the data masking module can sometimes analyze the recorded voice and attempt to detect time intervals that contain phrases, which are indicative of the sensitive data items. The data masking module may use any suitable voice recognition or speech processing method known in the art for this purpose. For example, when a data item that displays the customer credit card number is defined as a sensitive data item, the data masking module may attempt to detect the phrases “credit card number” or “card number,” followed by a sequence of enunciated digits or Dual Tone, Multi-Frequency (DTMF) tones, in the recorded voice.

In some cases, known audio analysis tools can be used to identify the sensitive data items in the contact center voice interaction, in order to enable masking these items. An exemplary tool, which can be used for this purpose, is the IntelliFind software, offered by Verint Systems Inc. IntelliFind generates a searchable indexed, categorized and ranked audio database from customer interactions in a contact center, and is sometimes integrated into the ULTRA contact center software, cited above.

Once the phrase is detected, the data masking module can mask the time interval, which contains the sequence indicating the credit card number in the recorded voice. For example, the masked audio can be replaced with a tone, a silent period, a noise-like signal, a dummy voice-like signal or any other suitable audible signal.

In some cases, the sensitive data items that are masked in the session voice are a subset of the items that are masked in the displayed session information. The rules and attributes defined for the sensitive data items may also be common, or partially common, to the voice masking and visual masking operations. In alternative embodiments, separate sets of sensitive data items can be defined for each medium.

Additionally or alternatively, the rules and attributes defined for the sensitive data items may be based, or partially based, on Computer-Telephony Integration (CTI) information that is provided as part of the voice interaction. CTI information may comprise, for example, signaling information of a voice call with a customer, specific menu selections the customer used in his or her interaction with an Interactive Voice Response (IVR) system, numerical or alphanumerical information the customer entered during the voice interaction, such as using DTMF, or any other information obtained as part of the voice interaction.

When the data masking module is able to interact with the CRM application, data from the CRM application that relates to the session can also be used for specifying and evaluating selective masking rules and conditions.

In the exemplary flow chart of FIG. 3 the sensitive data items are specified a-priori, i.e., before the sessions are conducted. In alternative embodiments, however, sensitive data items can be specified, modified or deleted at any time. For example, the sensitive data items can be specified after sessions have already been recorded. This feature enables the person specifying the sensitive data items to consider the recorded information in the specification process.

### Specification of Sensitive Data Items

The description of FIGS. 4 and 5 below shows an exemplary apparatus and method for specifying certain GUI objects, which are displayed as part of the GUI of a computerized application, as sensitive data items. The method of FIG. 5 below can be used to carry out item specification step 120 of the method of FIG. 3 above.

FIG. 4 is a block diagram that schematically illustrates an exemplary configuration of a definition terminal 148, in accordance with an embodiment of the present invention. Terminal 148 is used as a tool for specifying the sensitive data items in the application run by contact center 20. In some embodiments, the functionality of terminal 148 may be embodied in one or more of terminals 24. Alternatively, terminal 148 may comprise a workstation that is dedicated for specification tasks.

Terminal 148 comprises a network interface 150, which connects the terminal to network 32. The terminal comprises a Central Processing Unit (CPU) 154, which runs a suitable operating system 158, such as a Microsoft® Windows® operating system. The terminal also runs an instance 160 of the contact center application. Similar instances of this application are run by terminals 24. In some cases, the terminal may run two or more different applications 160. For example, a contact center representative may operate a CRM application while simultaneously interacting with a customer using an e-mail application.

The GUI of application 160 typically uses the GUI objects and features of operating system 158, such as windows, sub-windows, text boxes, check boxes, drop-down menus, lists, plots, graphs and/or any other GUI objects. These GUI objects can be used by interfacing with suitable Application Program Interfaces (APIs) of operating system 158. In particular, the operating system APIs can provide the current screen location of a particular GUI object. Terminal 24 further comprises an object identifier module 162, which is able to identify the GUI objects displayed by application 160 on display 44, typically using the APIs of operating system 158.

FIG. 5 is a flow chart that schematically illustrates a method for specifying sensitive data items for masking, in accordance with an embodiment of the present invention. The method begins with an administrative user, such as a system designer or administrator, conducting a session of application 160 on terminal 148, at an application running step 170. In parallel, terminal 148 runs object identifier 162, typically as a background task, at an identifier running step 174.

During the progress of the session, the user selects a certain GUI object of application 160 in order to indicate a corresponding sensitive data item, at an item selection step 178. The user selects a GUI object, which is displayed on display 44, and points to the object using input device 48. For example, the user may select a table entry that displays a client credit card number. The user can point and click on the desired GUI object using a mouse, scroll to the GUI object using keyboard arrow keys, or use any other suitable selection and input means.

Object identifier 162 interacts with the operating system APIs and determines the logical data item in the application, which corresponds to the GUI object selected by the user, at an item identification step 182. In some embodiments, object identifier 162 may also interact with application 160 for this purpose. It should be noted, however, that the method of FIG. 5 can be carried out with object identifier 162 communicating solely with operating system 158, without cooperation or interaction with application 160.

Any number of sensitive data items can be specified using this method. Additionally, the user may define rules and attributes for some or all of the specified sensitive data items using terminal 148. Once the sensitive data items are defined, terminal 148 typically distributes these definitions to agents 76 in terminals 24, to server 56 and/or to playback station 74, as applicable.

Although the embodiments described herein mainly address selective data masking in replayed contact center sessions, the principles of the present invention can also be used for selective information masking in any other form of interaction that involves computer screen activity, voice and/or other media types.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A computer-implemented method for session processing, comprising:
identifying a type of data item that is presented to a user by a computerized system;
recording a session in which the user interacts with the computerized system;
automatically detecting a data item of the identified type in the recorded session; and
replaying the recorded session, while refraining from presenting the detected data item in the replayed session.

2. The method according to claim 1, wherein the computerized system comprises a contact center application.

3. The method according to claim 1, wherein the computerized system provides the user with access to a remote computer by communicating with the remote computer over a communication link.

4. The method according to claim 1, wherein replaying the recorded session comprises presenting the replayed session to a reviewer different from the user, and wherein refraining from presenting the detected data item comprises preventing exposure of the data item to the reviewer.

5. The method according to claim 1, wherein the data item is displayed to the user on a computer display of the computerized system, and wherein refraining from presenting the detected data item comprises masking an area of the display in which the data item is displayed when replaying the session.

6. The method according to claim 5, wherein identifying the type of data item comprises identifying a logical definition of the type of data item in an application running on the computerized system, irrespective of a form in which the data item is displayed on the computer display.

7. The method according to claim 6, wherein identifying the logical definition comprises:
running the application on a definition terminal;
indicating a location on a display of the definition terminal in which the data item is displayed;
interacting with an operating system of the definition terminal, so as to determine a Graphical User Interface (GUI) object that is displayed at the indicated location and is associated with the data item; and
determining the logical definition of the type of data item based on the determined GUI object.

8. The method according to claim 1, wherein the computerized system comprises a voice communication system, wherein recording the session comprises recording voice that is exchanged between the user and the voice communication system, wherein automatically detecting the data item comprises automatically detecting an enunciation of the data item in the recorded voice, and wherein replaying the recorded session comprises replaying the recorded voice while refraining from enunciating the data item.

9. The method according to claim 1, wherein the computerized system presents electronic mail (e-mail) messages to the user during the session, and wherein refraining from presenting the detected data item comprises masking the detected data item in the e-mail messages that are presented in the replayed session.

10. The method according to claim 1, wherein recording the session comprises detecting and masking the data item at a computer with which the user interacts when recording the session.

11. The method according to claim 1, wherein recording the session comprises sending the recorded session over a network to a server, and detecting and masking the data item at the server.

12. The method according to claim 1, wherein recording the session comprises storing the recorded session in a storage device without omitting the data item, and wherein replaying the recorded session comprises retrieving the recorded session from the storage device and masking the data item when replaying the session.

13. The method according to claim 1, wherein recording the session comprises storing the recorded session in a storage device without omitting the data item, and comprising subsequently retrieving the recorded session, masking the data item and storing the session having the masked data item in the storage device.

14. The method according to claim 1, wherein identifying the type of data item comprises defining a condition, and wherein refraining from presenting the detected data item comprises evaluating the condition and refraining from presenting the detected data item when the condition is met.

15. The method according to claim 14, wherein the condition depends on at least one variable selected from a group of variables consisting of a value of the data item, a value of another data item, an authorization level of a reviewer who replays the session and an authorization level permitted to access the data item.

16. The method according to claim 14, wherein the computerized system comprises a voice communication system, wherein recording the session comprises recording voice interaction between the user and the voice communication system and Computer Telephony Integration (CTI) data associated with the voice interaction, and wherein the condition depends on the recorded CTI data.

17. The method according to claim 14, wherein evaluating the condition comprises interacting with an operating system on which the computerized system runs, without interacting with the computerized system directly.

18. The method according to claim 14, wherein the recorded session comprises recorded voice and recorded computer screen activity, wherein the condition depends on at least one information type selected from a group of types consisting of information obtained from the recorded voice and information obtained from the recorded computer screen activity, and wherein refraining from presenting the detected data item comprises masking the detected data item in at least one medium selected from a group of media consisting of replayed voice and replayed computer screen activity.

19. A session processing apparatus, comprising:
an input device and an output device, which are arranged to interact with a user of a computerized system; and
one or more processors, which are arranged to accept an identification of a type of data item that is presented to the user by the computerized system, to record a session in which the user interacts with the computerized system using the input and output devices, to automatically detect a data item of the identified type in the recorded session, and to replay the recorded session, while refraining from presenting the detected data item in the replayed session.

20. The apparatus according to claim 19, wherein the computerized system comprises a contact center application.

21. The apparatus according to claim 19, wherein the computerized system provides the user with access to a remote computer by communicating with the remote computer over a communication link.

22. The apparatus according to claim 19, wherein the output device comprises a computer display, wherein the data item is displayed to the user on the computer display, and wherein the processors are arranged to refrain from presenting the detected data item by masking an area of the display in which the data item is displayed when replaying the session.

23. The apparatus according to claim 22, wherein the processors are arranged to identify the type of data item by identifying a logical definition of the type of data item in an application running on the computerized system, irrespective of a form in which the data item is displayed on the computer display.

24. The apparatus according to claim 23, and comprising a definition terminal, which comprises a definition input device, a definition display and a definition processor, which is arranged to identify the logical definition of the type of data item by running the application, accepting an indication from the definition input device regarding a location on the definition display in which the data item is displayed, interacting with an operating system of the definition terminal so as to determine a Graphical User Interface (GUI) object that is displayed at the indicated location and is associated with the data item, and determining the logical definition of the type of data item based on the determined GUI object.

25. The apparatus according to claim 19, wherein the computerized system comprises a voice communication system, wherein the processors are arranged to record voice that is exchanged between the user and the voice communication system, to automatically detect an enunciation of the data item in the recorded voice, and to replay the recorded voice while refraining from enunciating the data item.

26. The apparatus according to claim 19, wherein the computerized system presents electronic mail (e-mail) messages to the user during the session, and wherein the processors are arranged to mask the detected data item in the e-mail messages that are presented in the replayed session.

27. The apparatus according to claim 19, wherein the one or more processors comprise:
a first processor, which resides in a user terminal that is connected to the input and output devices with which the user interacts and is arranged to record the session and to send the recorded session over a network; and
a second processor, which is separate from the first processor and is connected to the first processor via the network, and is arranged to accept the recorded session over the network and to replay the session,
wherein one of the first and second processors is arranged to detect and omit the data item from the recorded session.

28. The apparatus according to claim 19, wherein at least one of the processors resides in a user terminal that is connected to the input and output devices with which the user interacts, and is arranged to record the session and to detect and mask the data item at the user terminal when recording the session.

29. The apparatus according to claim 19, wherein the one or more processors comprise:
a first processor, which resides in a user terminal that is connected to the input and output devices with which the user interacts and is arranged to record the session and to send the recorded session over a network; and
a second processor, which resides in a server that is separate from the user terminal and is connected to the user terminal via the network, wherein the second processor is arranged to accept the recorded session over the network and to detect and mask the data item.

30. The apparatus according to claim 19, wherein the processors are arranged to store the recorded session in a storage device without omitting the data item, to retrieve the recorded session from the storage device in order to replay the session, and to mask the data item when replaying the session.

31. The apparatus according to claim 19, wherein the processors are arranged to store the recorded session in a storage device without omitting the data item, and to subsequently retrieve the recorded session, mask the data item and store the session having the masked data item in the storage device.

32. The apparatus according to claim 19, wherein the identification of the type of data item comprises a condition, and wherein the processors are arranged to evaluate the condition and to refrain from presenting the detected data item when the condition is met.

33. The apparatus according to claim 32, wherein the condition depends on at least one variable selected from a group of variables consisting of a value of the data item, a value of another data item, an authorization level of a reviewer who replays the session and an authorization level permitted to access the data item.

34. The apparatus according to claim 32, wherein the computerized system comprises a voice communication system, wherein the processors are arranged to record voice interaction between the user and the voice communication system and Computer Telephony Integration (CTI) data associated with the voice interaction, and wherein the condition depends on the recorded CTI data.

35. The apparatus according to claim 32, wherein the processors are arranged to evaluate the condition by interacting with an operating system on which the computerized system runs, without direct interaction with the computerized system.

36. The apparatus according to claim 32, wherein the recorded session comprises recorded voice and recorded computer screen activity, wherein the condition depends on at least one information type selected from a group of types consisting of information obtained from the recorded voice and information obtained from the recorded computer screen activity, and wherein the processors are arranged to mask the detected data item in at least one medium selected from a group of media consisting of replayed voice and replayed computer screen activity.

37. A session processing apparatus, comprising:
means for identifying a type of data item that is presented to a user by a computerized system;
means for recording a session in which the user interacts with the computerized system;
means for automatically detecting a data item of the identified type in the recorded session; and
means for replaying the recorded session, while refraining from presenting the detected data item in the replayed session.

38. A computer software product for session processing, the product comprising a computer-readable medium, in which program instructions are stored, which instructions, when read by one or more processors, cause the processors to interact with a user of a computerized system, to accept an identification of a type of data item that is presented to the user by the computerized system, to record a session in which the user operates the computerized system using the input and output devices, to automatically detect a data item of the identified type in the recorded session, and to replay the recorded session, while refraining from presenting the detected data item in the replayed session.
